(19) United States
(12) Patent Application Publication
(10) Pub. No.: US 2022/0045448 A1
(43) Pub. Date: Feb. 10, 2022

(54) ELECTRICAL CONNECTOR AND ELECTRICAL CONNECTOR DEVICE

(71) Applicant: I-PEX Inc., Kyoto-shi (JP)

(72) Inventor: Takeshi HIRAKAWA, Tokyo (JP)

(73) Assignee: I-PEX Inc., Kyoto-shi (JP)

(21) Appl. No.: 17/452,090

(22) Filed: Oct. 25, 2021

Related U.S. Application Data
(63) Continuation of application No. PCT/JP2020/017397, filed on Apr. 22, 2020.

(30) Foreign Application Priority Data
May 15, 2019 (JP) 2019-092440

(51) Int. Cl. H01R 12/71; H01R 13/639; H01R 13/405; H01R 13/502

(52) U.S. Cl. CPC H01R 12/716; H01R 13/502; H01R 13/405; H01R 13/639

(57) ABSTRACT

An electrical connector includes a housing, and a contact that is attached to the housing and is connected to a wiring substrate, wherein the contact includes a connection part that is connected to the wiring substrate, a holding part that is joined to the connection part and extends in a direction away from the wiring substrate, a joining part that is joined to the holding part through a folding part, extends in a direction closer to the wiring substrate, extends so as to be provided along a principal surface of the wiring substrate, and further extends in a direction away from the wiring substrate, and a contact part that is joined to the joining part and contacts a counterpart contact of a counterpart connector, and the joining part contacts the holding part.

### CROSS-REFERENCE TO RELATED APPLICATION(S)

This application is a continuation application of International Application No. PCT/JP2020/017397, filed on Apr. 22, 2020, which designates the United States and is incorporated by reference herein in its entirety, and which claims the benefit of priority to Japanese Patent Applications No. 2019-092440, filed on May 15, 2019, which is incorporated by reference herein in its entirety.

### BACKGROUND OF THE INVENTION

### 1. Field of the Invention

A disclosed embodiment(s) relate(s) to an electrical connector and an electrical connector device.

### 2. Description of the Related Art

A connector has conventionally been known where, when an electrical connector is mated with a counterpart connector, a contact of the electrical connector is elastically deformed so as to cause contact between the contact of the electrical connector and a contact of the counterpart connector, so that the electrical connector and the counterpart connector are electrically connected (see, for example, Japanese Patent Application Publication No. 2004-119048).

In a connector (a connector 10) as described in Japanese Patent Application Publication No. 2004-119048, a folding part (an intermediate coupling part 25) is provided on a contact (a contact 15) where, at a time of mating with a counterpart connector (a plug 13), the folding part (the intermediate coupling part 25) of the contact (the contact 15) and a joining part (a contact part 23) that is joined thereto are elastically deformed so as to cause contact between both contacts (contacts 15, 17).

However, in a case where an electrical connector as described above is mated with a counterpart connector, a stress may concentrate on a folding part so as to degrade the folding part. That is, it is difficult to ensure durability of an electrical connector.

### SUMMARY OF THE INVENTION

An electrical connector according to an aspect of an embodiment includes a housing, and a contact that is attached to the housing and is connected to a wiring substrate, wherein the contact includes a connection part that is connected to the wiring substrate, a holding part that is joined to the connection part and extends in a direction away from the wiring substrate, a joining part that is joined to the holding part through a folding part, extends in a direction closer to the wiring substrate, extends so as to be provided along a principal surface of the wiring substrate, and further extends in a direction away from the wiring substrate, and a contact part that is joined to the joining part and contacts a counterpart contact of a counterpart connector, and the joining part contacts the holding part.

### BRIEF DESCRIPTION OF THE DRAWING(S)

FIG. 1 is a perspective view of a connector where a plug connector and a receptacle connector are illustrated separately.

FIG. 2 is a diagram that illustrates a mating state of a plug connector and a receptacle connector.

FIG. 3 is a perspective view of a plug connector.

FIG. 4 is a plan view of a plug connector.

FIG. 5 is a V-V cross-sectional view of FIG. 4.

FIG. 6 is a perspective view of a contact of a plug connector.

FIG. 7 is a plan view of a receptacle connector.

FIG. 8 is a VIII-VIII cross-sectional view of FIG. 7.

FIG. 9 is a perspective view of a contact of a receptacle connector.

FIG. 10 is a plan view of a connector.

FIG. 11 is an XI-XI cross-sectional view of FIG. 10.

FIG. 12 is a diagram that illustrates a stress distribution of a receptacle connector according to a comparative example in a mating state thereof.

FIG. 13 is a diagram that illustrates a stress distribution of a receptacle connector according to an embodiment in a mating state thereof.

### DETAILED DESCRIPTION OF THE PREFERRED EMBODIMENT(S)

Hereinafter, an electrical connector and an electrical connector device as disclosed in the present application will be explained with reference to the accompanying drawing(s). Additionally, this invention is not limited by an embodiment(s) as illustrated below.

1. Outline of Connector

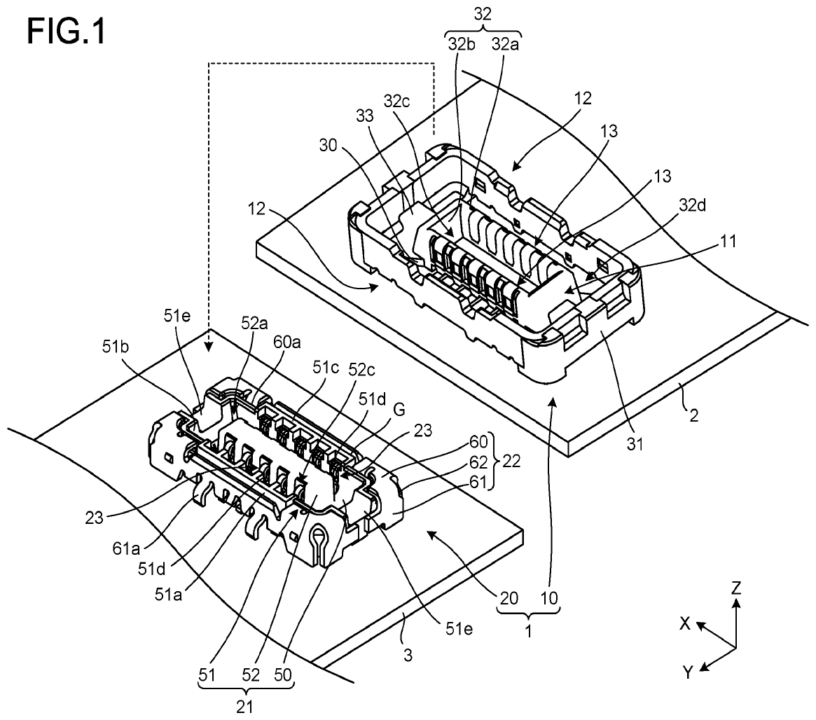

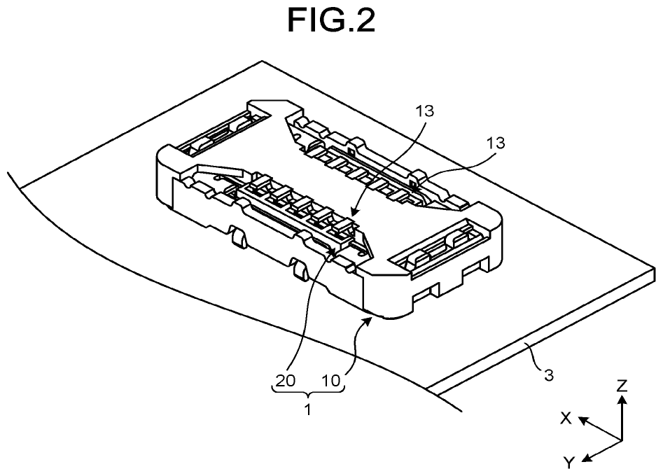

First, an outline of a connector 1 (an electrical connector device) according to an embodiment will be explained with reference to FIG. 1 and FIG. 2. The connector 1 according to an embodiment has a plug connector 10 (a counterpart connector) and a receptacle connector 20 (an electrical connector). The plug connector 10 is attached to a wiring substrate 2. Furthermore, the receptacle connector 20 is attached to a wiring substrate 3.

Furthermore, hereinafter, for explanatory convenience, a direction where the plug connector 10 is inserted into the receptacle connector 20 (a negative direction of a Z-axis) is provided as a “downward direction” and a removal direction (a positive direction of the Z-axis) that is an opposite direction thereof is provided as an “upward direction”.

Furthermore, longitudinal directions (positive and negative directions of an X-axis) of the plug connector 10 and the receptacle connector 20 are provided as “leftward and rightward directions”. Furthermore, transverse directions (positive and negative directions of a Y-axis) of the plug connector 10 and the receptacle connector 20 are provided as “forward and backward directions”.

In the connector 1, the plug connector 10 and the receptacle connector 20 are moved closer in a state where the plug connector 10 faces the receptacle connector 20, so that the plug connector 10 is mated with the receptacle connector 20. Additionally, for explanatory convenience, the plug connector 10 that is attached to the wiring substrate 2 as illustrated in FIG. 1 is illustrated in a state where it is separated and is overturned, and when it is mated with the receptacle connector 20, it is mated therewith along an arrow (a dotted line).

Thereby, contact between a contact(s) 13 of the plug connector 10 and a contact(s) 23 of the receptacle connector 20 is caused, so that a plurality of contacts 13 that are provided on the plug connector 10 and a plurality of contacts 23 that are provided on the receptacle connector 20 are electrically connected respectively. That is, a plurality of signal electrically conducting paths (non-illustrated) that are formed on the wiring substrate 2 and a plurality of signal electrically conducting paths (non-illustrated) that are formed on the wiring substrate 3 are electrically connected respectively through the contacts 13, 23.

2. Plug Connector

Next, a configuration of a plug connector 10 will be explained with reference to FIG. 1 and FIG. 3 to FIG. 6. Additionally, hereinafter, an explanation(s) will be provided by using XYZ coordinates in a state where the plug connector 10 is mated with a receptacle connector 20. Hence, positive and negative directions of a Z-axis for a plug connector 10 as illustrated in FIG. 1 are opposite directions.

The plug connector 10 has a housing 11, a shell member 12, and a plurality of contacts 13.

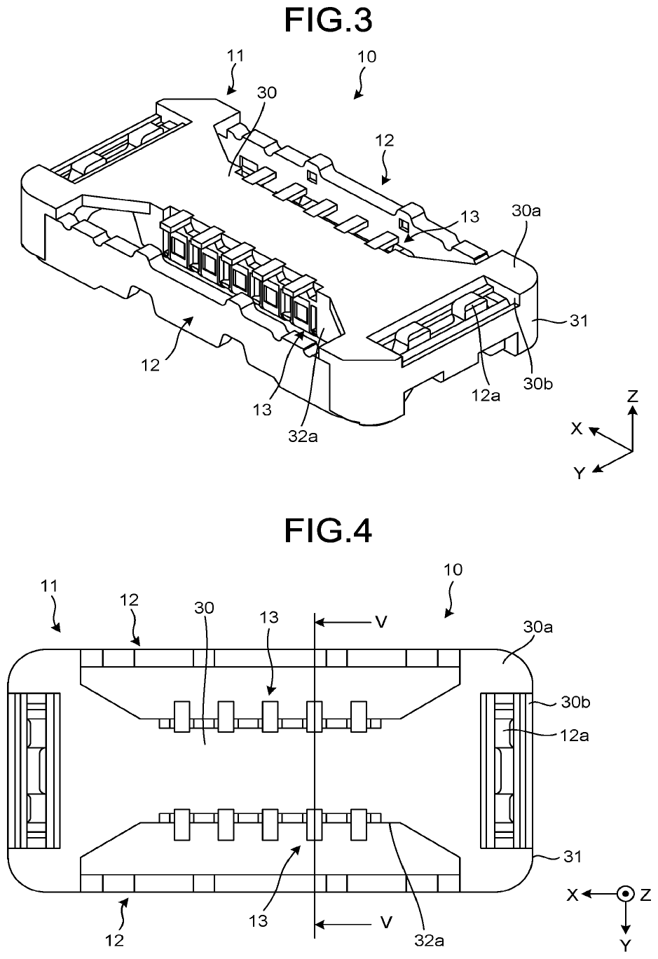

The housing 11 is formed of an insulating resin. The housing 11 has an upper wall part 30 and a side wall part(s) 31, as illustrated in FIG. 3 and FIG. 4. Furthermore, the housing 11 has a first protrusion part 32 and a second protrusion part 33, as illustrated in FIG. 1.

The upper wall part 30 is of a flat plate shape and is formed so as to extend along leftward and rightward directions (positive and negative directions of an X-axis), as illustrated in FIG. 3 and FIG. 4. Furthermore, at both ends of the upper wall part 30 in leftward and rightward directions, an extension part 30a that extends along forward and backward directions (positive and negative directions of a Y-axis) is formed on each of end parts thereof. A recess part 30b that exposes a contact part 12a of the shell member 12 is formed between respective extension parts 30a.

Side wall parts 31 are formed along a downward direction (a negative direction of a Z-axis) from both ends of the upper wall part 30 in leftward and rightward directions and peripheries of the extension parts 30a, as illustrated in FIG. 3.

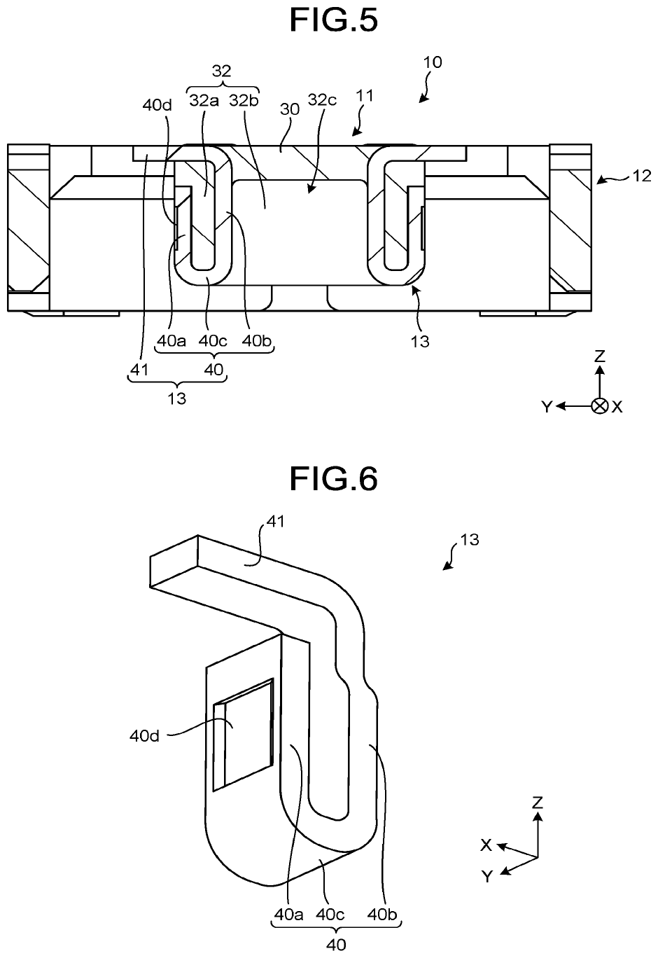

The first protrusion part 32 protrudes toward a downward direction (a negative direction of a Z-axis) from the upper wall part 30 at a substantially central position of the housing 11 in leftward and rightward directions (positive and negative directions of an X-axis), as illustrated in FIG. 1 and FIG. 5. The first protrusion part 32 has a first wall part(s) 32a and a second wall part(s) 32b. A first wall part 32a is formed so as to extend along leftward and rightward directions (positive and negative directions of an X-axis). A pair of first wall parts 32a is formed side by side in forward and backward directions (positive and negative directions of a Y-axis). The plurality of contacts 13 are arranged side by side in leftward and rightward directions (positive and negative directions of an X-axis) on each first wall part 32a while a predetermined interval(s) is/are provided therebetween.

A second wall part 32b is formed so as to extend along forward and backward directions (positive and negative directions of a Y-axis). A pair of second wall parts 32b is formed side by side in leftward and rightward directions (positive and negative directions of an X-axis). Respective second wall parts 32b connect ends of the pair of first wall parts 32a in leftward and rightward directions (positive and negative directions of an X-axis).

That is, the first protrusion part 32 is formed into a frame shape by the first wall parts 32a and the second wall parts 32b as illustrated in FIG. 1 and forms a recess part 32c at a center thereof as illustrated in FIG. 1 and FIG. 5.

The second protrusion part 33 protrudes from the upper wall part 30 toward a downward direction (a negative direction of a Z-axis) near end parts of the housing 11 in leftward and rightward directions (positive and negative directions of an X-axis), as illustrated in FIG. 1. The second protrusion part 33 is formed between a second wall part 32b of the first protrusion part 32 and a side wall part 31. An amount of protrusion of the second protrusion part 33 is less than an amount of protrusion of the first protrusion part 32.

The shell member 12 is formed by bending—processing an electrically conductive metallic member that is formed into a plate shape. The shell member 12 is fixed on the housing 11 by, for example, insert molding. The shell member 12 is formed into a frame shape and is formed so as to cover at least a part of the housing 11. A gap is formed between the shell member 12 and the first protrusion part 32 of the housing 11. That is, a recess part 32d with a frame shape is formed around the first protrusion part 32 of the housing 11. Additionally, the shell member 12 may be formed of a plurality of members such as two shell members 12 that are respectively arranged symmetrically relative to a central position in forward and backward directions (positive and negative directions of a Y-axis) like the present embodiment, or may be formed of one member.

A plurality of contact parts 12a are formed on both ends of the shell member 12 in leftward and rightward directions (positive and negative directions of an X-axis), as illustrated in FIG. 3 and FIG. 4. Each contact part 12a is connected to a ground electrically conducting path (non-illustrated) of a wiring substrate 2 (see FIG. 1). For example, each contact part 12a is solder-jointed to a ground electrically conducting path of the wiring substrate 2.

A contact 13 is formed of an electrically conductive metallic member. For example, a contact 13 is formed by a punching process, a bending process, or the like. A contact 13 is fixed on the housing 11 by, for example, insert molding. The plurality of contacts 13 are arranged along leftward and rightward directions (positive and negative directions of an X-axis) while a predetermined interval(s) is/are provided therebetween, as illustrated in FIG. 1, FIG. 3, FIG. 4, and FIG. 5. The plurality of contacts 13 are arranged on each first wall part 32a of the first protrusion part 32. That is, the plurality of contacts 13 are arranged in two columns in forward and backward directions (positive and negative directions of a Y-axis).

A contact 13 has a contact part 40 and a terminal part 41, as illustrated in FIG. 5 and FIG. 6. Additionally, FIG. 6 illustrates a contact 13 that is arranged on a first wall part 32a in a forward direction, in the pair of first wall parts 32a, as an example thereof.

The contact part 40 is formed into a U-shape. The contact part 40 has a first arm part 40a, a second arm part 40b, and a connection part 40c. The first arm part 40a is formed along upward and downward directions (positive and negative directions of a Z-axis). A recess part 40d is formed on a surface of the first arm part 40a that is exposed from a first wall part 32a of the housing 11.

The second arm part 40b is formed along upward and downward directions (positive and negative directions of a Z-axis). The connection part 40c joins a lower end of the first arm part 40a and a lower end of the second arm part 40b. The first arm part 40a, a part of the second arm part 40b, and the connection part 40c are exposed from a first wall part 32a of the housing 11, as illustrated in FIG. 5.

The terminal part 41 is formed from an upper end of the second arm part 40b along frontward and backward directions. Specifically, the terminal part 41 protrudes from an upper end of the second arm part 40b toward the first arm part 40a. The terminal part 41 is exposed from the upper wall part 30 of the housing 11, as illustrated in FIG. 5. The terminal part 41 is connected to a signal electrically conducting path (non-illustrated) of the wiring substrate 2 (see FIG. 1). For example, the terminal part 41 is solder-jointed to a signal electrically conducting path of the wiring substrate 2.

An orientation of a contact 13 is different depending on a first wall part 32a where it is fixed. Specifically, a contact 13 that is fixed on a first wall part 32a in a forward direction (a positive direction of a Y-axis) is arranged in such a manner that a tip of a terminal part 41 is oriented in a forward direction. Furthermore, a contact 13 that is fixed on a first wall part 32a in a backward direction (in a negative direction of a Y-axis) is arranged in such a manner that a tip of a terminal part 41 is oriented in a backward direction. For contacts 13 that are arranged side by side in frontward and backward directions, second arm parts 40b face one another across the recess part 32c that is formed on the first protrusion part 32, as illustrated in FIG. 5.

3. Receptacle Connector

Next, a configuration of a receptacle connector 20 will be explained with reference to FIG. 1 and FIG. 7 to FIG. 9. The receptacle connector 20 has a housing 21, a shell member 22 (shell), and a plurality of contacts 23.

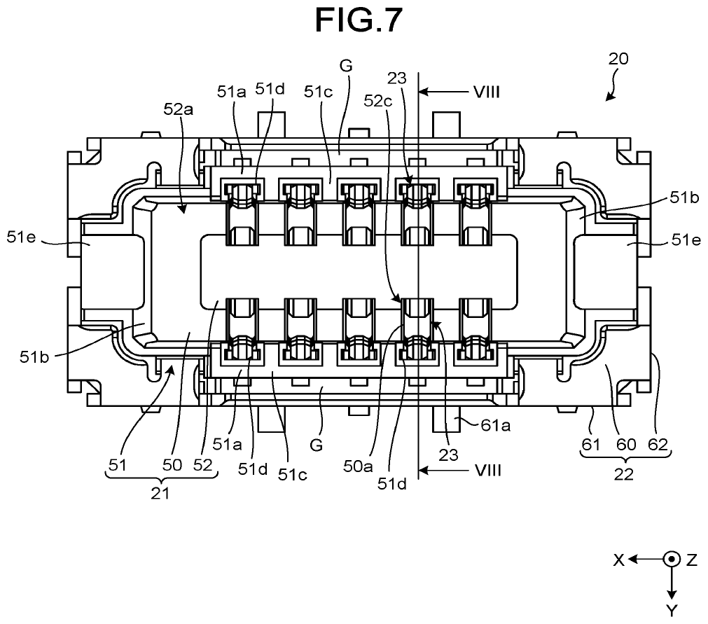

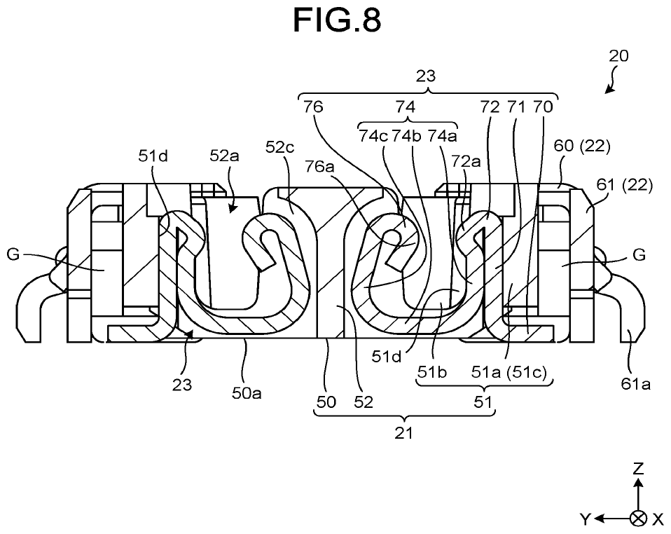

The housing 21 is formed of an insulating resin member. The housing 21 has a bottom wall part 50, a side wall part 51, and a central wall part 52, as illustrated in FIG. 1, FIG. 7, and FIG. 8.

The bottom wall part 50 is of a flat plate shape and is formed so as to extend along leftward and rightward directions (positive and negative directions of an X-axis). A hole(s) 50a that expose(s) a contact(s) 23 is/are formed on the bottom wall part 50, as illustrated in FIG. 7 and FIG. 8. A plurality of holes 50a are formed along leftward and rightward directions while a predetermined interval(s) is/are provided therebetween. Furthermore, holes 50a are formed in two columns in forward and backward directions (positive and negative directions of a Y-axis).

The side wall part 51 protrudes toward an upward direction from the bottom wall part 50. The side wall part 51 has a first wall part(s) 51a and a second wall part(s) 51b, as illustrated in FIG. 1, FIG. 7, and FIG. 8. A first wall part 51a is formed so as to extend along leftward and rightward directions (positive and negative directions of an X-axis). A pair of first wall parts 51a is formed side by side in forward and backward directions (positive and negative directions of a Y-axis).

A protrusion part(s) 51c that protrude(s) in forward and backward directions (positive and negative directions of a Y-axis) is/are formed on a first wall part 51a. Specifically, a protrusion part 51c that protrudes toward a forward direction is formed on a first wall part 51a in a forward direction (a positive direction of a Y-axis) in the pair of first wall parts 51a. Furthermore, a protrusion part 51c that protrudes toward a backward direction is formed on a first wall part 51a in a backward direction (a negative direction of a Y-axis) in the pair of first wall parts 51a. A recess part(s) 51d where a contact(s) 23 is/are arranged is/are formed on the protrusion part(s) 51c.

A plurality of recess parts 51d are formed in leftward and rightward directions (positive and negative directions of an X-axis) while a predetermined interval(s) is/are provided therebetween, as illustrated in FIG. 1 and FIG. 7. A recess part 51d is formed so as to dent in forward and backward directions (positive and negative directions of a Y-axis). Specifically, a recess part 51d that is formed on a first wall part 51a in a frontward direction (a positive direction of a Y-axis) in the pair of first wall parts 51a is formed so as to dent in a forward direction. Furthermore, a recess part 51d that is formed on a first wall part 51a in a backward direction (a negative direction of a Y-axis) in the pair of first wall parts 51a is formed so as to dent in a backward direction. A lower end of a recess part 51d is communicated with a hole 50a that is formed on the bottom wall part 50, as illustrated in FIG. 8.

A second wall part 51b is formed so as to extend along forward and backward directions (positive and negative directions of a Y-axis), as illustrated in FIG. 1 and FIG. 7. A pair of second wall parts 51b is formed side by side in leftward and rightward directions (positive and negative directions of an X-axis). Respective second wall parts 51b connect ends of the pair of first wall parts 51a in leftward and rightward directions. That is, the side wall part 51 is formed into a frame shape by the first wall parts 51a and the second wall parts 51b.

Furthermore, a recess part(s) 51e that dent(s) toward leftward and rightward directions (positive and negative directions of an X-axis) is/are formed on a second wall part(s) 51b. Specifically, a recess part 51e that is formed on a second wall part 51b in a leftward direction (a positive direction of an X-axis) in the pair of second wall parts 51b protrudes toward a leftward direction. Furthermore, a recess part 51e that is formed on a second wall part 51b in a rightward direction (a negative direction of an X-axis) in the pair of second wall parts 51b protrudes toward a rightward direction. A second protrusion part 33 (see FIG. 1) of a plug connector 10 engages with a recess part 51e.

The central wall part 52 is formed on an area that is surrounded by the side wall part 51 and protrudes from the bottom wall part 50 toward an upward direction (a positive direction of a Z-axis) at a substantially central position of the housing 21 in leftward and rightward directions (positive and negative directions of an X-axis) and a substantially central position thereof in forward and backward directions (positive and negative directions of a Y-axis), as illustrated in FIG. 1, FIG. 7, and FIG. 8. The central wall part 52 is formed so as to extend along leftward and rightward directions. A recess part 52a that dents toward a downward direction is formed between the central wall part 52 and the side wall part 51. The recess part 52a is formed around the central wall part 52. That is, the recess part 52a is formed into a frame shape.

Furthermore, a recess part(s) 52c where a contact(s) 23 is/are arranged is/are formed on the central wall part 52. A plurality of recess parts 52c are formed in leftward and rightward directions (positive and negative directions of an X-axis) while a predetermined interval(s) is/are provided therebetween, as illustrated in FIG. 1 and FIG. 7. Furthermore, recess parts 52c are formed in two columns in forward and backward directions (positive and negative directions of a Y-axis). A recess part 52c is formed so as to dent in forward and backward directions (positive and negative directions of a Y-axis). Specifically, a recess part 52c that is formed in a forward direction (a positive direction of a Y-axis) is formed so as to dent in a backward direction (a negative direction of a Y-axis). Furthermore, a recess part 52c that is formed in a backward direction is formed so as to dent in a forward direction. Furthermore, a lower end of a recess part 52c is communicated with a hole 50a that is formed on the bottom wall part 50, as illustrated in FIG. 8.

The shell member 22 is formed by bending-processing an electrically conductive metallic member that is formed into a plate shape. The shell member 22 is fixed on the housing 21 by, for example, press fitting or insert molding. The shell member 22 is formed around the side wall part 51 of the housing 21 and is formed so as to cover at least a part of the housing 21, as illustrated in FIG. 1, FIG. 7, and FIG. 8. The shell member 22 has an upper wall part 60, a first side wall part(s) 61, and a second side wall part(s) 62. Additionally, the shell member 22 may be formed of a plurality of members such as two shell members 22 that are respectively arranged symmetrically relative to a central position in forward and backward directions (positive and negative directions of a Y-axis) like the present embodiment, or may be formed of one member.

An opening part 60a that is capable of inserting a first protrusion part 32, a second protrusion part 33, and/or the like of the plug connector 10 into the recess part 52a is formed on the upper wall part 60, as illustrated in FIG. 1.

First side wall parts 61 are formed from both ends of the upper wall part 60 in forward and backward directions (positive and negative directions of a Y-axis) toward a downward direction (a negative direction of a Z-axis), as illustrated in FIG. 1, FIG. 7, and FIG. 8. A gap G is formed between a first side wall part 61 and a protrusion part 51c of a first wall part 51a of the housing 21. A gap G is formed so as to be capable of viewing a tip of a terminal part 70 of a contact 23 as described later from an upward direction (a positive direction of a Z-axis), as illustrated in FIG. 7 and FIG. 8.

A plurality of contact parts 61a that protrude toward a downward direction (a negative direction of a Z-axis) are formed on a first side wall part 61, as illustrated in FIG. 1, FIG. 7, and FIG. 8. Each contact part 61a is connected to a ground electrically conducting path (non-illustrated) of a wiring substrate 3 (see FIG. 1 or the like). For example, each contact part 61a is solder-jointed to a ground electrically conducting path of the wiring substrate 3.

Second side wall parts 62 are formed from both ends of the upper wall part 60 in leftward and rightward directions (positive and negative directions of an X-axis) toward a downward direction (a negative direction of a Z-axis), as illustrated in FIG. 1 and FIG. 7.

A contact 23 is formed of an electrically conductive metallic member. For example, a contact 23 is formed by a punching process, a bending process, or the like. A contact 23 is fixed on a first wall part 51a of the housing 21 by, for example, press fitting or insert molding. The plurality of contacts 23 are arranged along leftward and rightward directions (positive and negative directions of an X-axis) while a predetermined interval(s) is/are provided therebetween. The plurality of contacts 23 are arranged on each first wall part 51a. Moreover, the plurality of contacts 23 are arranged in two columns in forward and backward directions (positive and negative directions of a Y-axis).

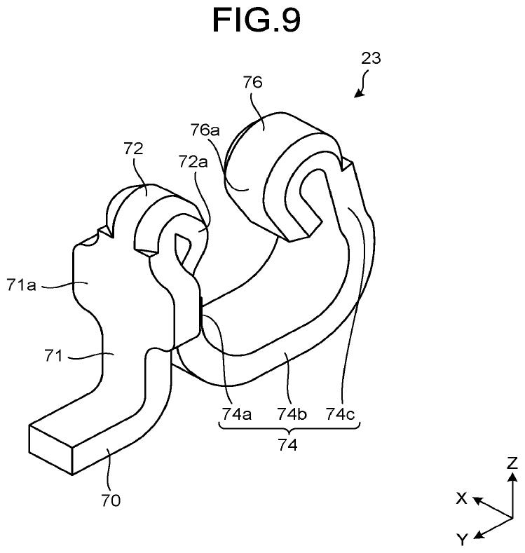

A contact 23 has a terminal part 70 (a connection part), a holding part 71, a folding part 72, a joining part 74, and a contact part 76, as illustrated in FIG. 8 and FIG. 9. Additionally, FIG. 9 illustrates a contact 23 that is fixed on a first wall part 51a in a frontward direction, as an example, in the pair of first wall parts 51a.

The terminal part 70 is formed so as to extend along forward and backward directions (positive and negative directions of a Y-axis). The terminal part 70 is connected to a signal electrically conducting path (non-illustrated) of the wiring substrate 3 (see FIG. 1 or the like). For example, the terminal part 70 is solder-jointed to a signal electrically conducting path of the wiring substrate 3.

The holding part 71 is joined to an end part of the terminal part 70 near the central wall part 52 and is formed from the end part of the terminal part 70 toward an upward direction (a positive direction of a Z-axis). That is, the holding part 71 extends in a direction away from the wiring substrate 3 (see FIG. 1). The holding part 71 contacts a first wall part 51a of the housing 21, as illustrated in FIG. 8. The holding part 71 contacts a first wall part 51a of the housing 21, so that movement of a contact 23 toward the side wall part 51 is limited. The holding part 71 has an extension part 71a with a length in leftward and rightward directions (positive and negative directions of an X-axis) that is greater than that of the terminal part 70 or the like where the extension part 71a is positioned at a recess part 51d that is formed on the housing 21, so as to hold a contact 23, as illustrated in FIG. 9.

The folding part 72 is formed into an inverted U-shape where one end part thereof is jointed to an upper end of the holding part 71. The folding part 72 is formed in such a manner that another end part thereof is provided near the central wall part 52.

A proximal end contact part 72a is formed on another end part of the folding part 72. The proximal end contact part 72a is formed toward a downward direction (a negative direction of a Z-axis). The proximal end contact part 72a protrudes toward the central wall part 52, as illustrated in FIG. 8. In other words, the proximal end contact part 72a protrudes toward the contact part 76.

The joining part 74 is formed into a U-shape and has a first arm part 74a, a second arm part 74b, and a third arm part 74c. An upper end of the first arm part 74a is joined to a lower end of the proximal end contact part 72a. The first arm part 74a is formed from a lower end of the proximal end contact part 72a toward a downward direction. The first arm part 74a extends from the proximal end contact part 72a in a direction closer to the wiring substrate 3 (see FIG. 1). The first arm part 74a is formed so as to face the holding part 71 and contacts the holding part 71. That is, the joining part 74 contacts the holding part 71 by the first arm part 74a.

The second arm part 74b is formed so as to extend from a lower end of the first arm part 74a along forward and backward directions. Specifically, the second arm part 74b is formed from a lower end of the first arm part 74a toward the central wall part 52, as illustrated in FIG. 8. The second arm part 74b extends so as to be provided along a principal surface of the wiring substrate 3 (see FIG. 1).

Additionally, the second arm part 74b is formed in such a manner that, in a state where the plug connector 10 (see FIG. 1 or the like) is not mated therewith, a lower end of the second arm part 74b is positioned in an upward direction (a positive direction of a Z-axis) relative to a lower end of the terminal part 70 and a gap is generated between it and the wiring substrate 3 (see FIG. 1). That is, in a case where the plug connector 10 (see FIG. 1 or the like) is not mated therewith, the second arm part 74b is provided in a state where it is separated from the wiring substrate 3.

The third arm part 74c is formed from an end part of the second arm part 74b near the central wall part 52 toward an obliquely upward direction. Specifically, the third arm part 74c is formed in such a manner that an upper end of the third arm part 74c is provided nearer the first arm part 74a than a lower end of the third arm part 74c. The third arm part 74c extends so as to be away from the wiring substrate 3 (see FIG. 1). In a state where the plug connector 10 (see FIG. 1 or the like) is not mated therewith, the third arm part 74c is formed so as to generate a gap between it and the central wall part 52. That is, in a case where the plug connector 10 (see FIG. 1 or the like) is not mated therewith, the third arm part 74c is provided in a state where it is separated from the central wall part 52.

The contact part 76 is formed into an inverted U-shape where one end part thereof is jointed to an upper end of the third arm part 74c. The contact part 76 is folded into an inverted U-shape relative to the third arm part 74c and is jointed to an upper end of the third arm part 74c (a tip of the joining part 74). A distal end contact part 76a is formed near a distal end of the contact part 76.

The contact part 76 is formed in such a manner that another end part thereof is provided nearer the proximal end contact part 72a than one end part thereof. Another end part of the contact part 76 is formed so as to be inclined toward an obliquely downward direction. Specifically, another end part of the contact part 76 is formed so as to be inclined in such a manner that a lower end thereof is provided near the third arm part 74c.

An orientation of a contact 23 is different depending on a first wall part 51a where it is fixed. Specifically, a contact 23 that is fixed on a first wall part 51a in a forward direction (a positive direction of a Y-axis) is arranged in such a manner that a terminal part 70 is provided in a forward direction and a contact part 76 is provided in a backward direction (a negative direction of a Y-axis), as illustrated in FIG. 8. Furthermore, a contact 23 that is fixed on a first wall part 51a in a backward direction is arranged in such a manner that a terminal part 70 is provided in a backward direction and a contact part 76 is provided in a forward direction. For contacts 23 that are arranged side by side in frontward and backward directions, third arm parts 74c of joining parts 74 face one another across the central wall part 52.

For a contact 23, the distal end contact part 76a is formed near a distal end of the contact part 76 of the contact 23 and the proximal end contact part 72a is formed near a proximal end of the joining part 74 on the folding part 72. Then, a contact 23 is formed in such a manner that the joining part 74 faces the holding part 71 and a part of the joining part 74, specifically, the first arm part 74a, contacts the holding part 71.

Furthermore, in a case where the plug connector 10 is not mated with the receptacle connector 20, the second arm part 74b of the joining part 74 (a part of the joining part 74) does not contact the wiring substrate 3 and the third arm part 74c of the joining part 74 (a part of the joining part 74) does not contact the central wall part 52. Hence, in a case where the plug connector 10 is not mated with the receptacle connector 20, the joining part 74 of a contact 23 is capable of being elastically deformed in a state where the first arm part 74a is held by the holding part 71.

4. Mating of Plug Connector and Receptacle Connector

An insertion state in a case where a plug connector 10 is mated with a receptacle connector 20 will be explained with reference to FIG. 1. In a case where the plug connector 10 is mated with the receptacle connector 20, a central wall part 52 of the receptacle connector 20 is inserted into a recess part 32c that is formed on a first protrusion part 32 of the plug connector 10. Furthermore, the first protrusion part 32 of the plug connector 10 is inserted into a recess part 52a that is formed around the central wall part 52 of the receptacle connector 20. Furthermore, a shell member 22 and a part of a side wall part 51 of a housing 21 of the receptacle connector 20 are inserted into a recess part 32d that is formed around the first protrusion part 32 of the plug connector 10.

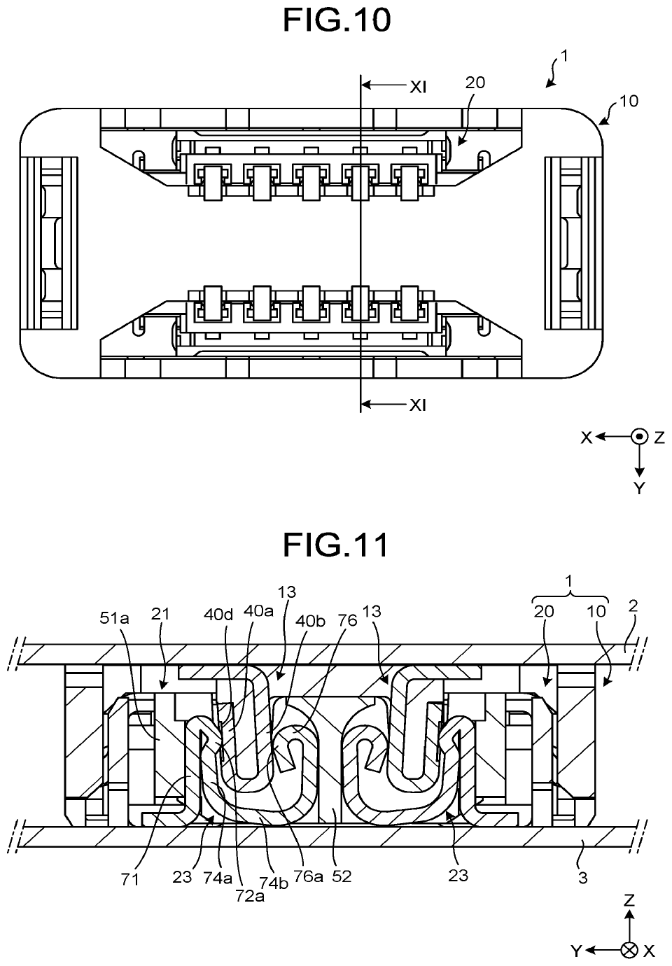

Next, a state where the plug connector 10 is mated with the receptacle connector 20 will be explained with reference to FIG. 10 and FIG. 11. Additionally, FIG. 11 illustrates wiring substrates 2, 3 for an explanation(s).

As the plug connector 10 is mated with the receptacle connector 20, contact between a contact 13 of the plug connector 10 and a contact 23 of the receptacle connector 20 is caused as illustrated in FIG. 11.

Specifically, a proximal end contact part 72a on a folding part 72 of a contact 23 of the receptacle connector 20 engages with a recess part 40d that is formed on a first arm part 40a of the plug connector 10 so as to contact the first arm part 40a. Furthermore, a distal end contact part 76a on a contact part 76 of a contact 23 of the receptacle connector 20 contacts a second arm part 40b of the plug connector 10.

That is, a contact 23 of the receptacle connector 20 interposes between the proximal end contact part 72a and the distal end contact part 76a, and contacts, a contact 13 of the plug connector 10. Thereby, a contact 13 of the plug connector 10 and a contact 23 of the receptacle connector 20 are electrically connected.

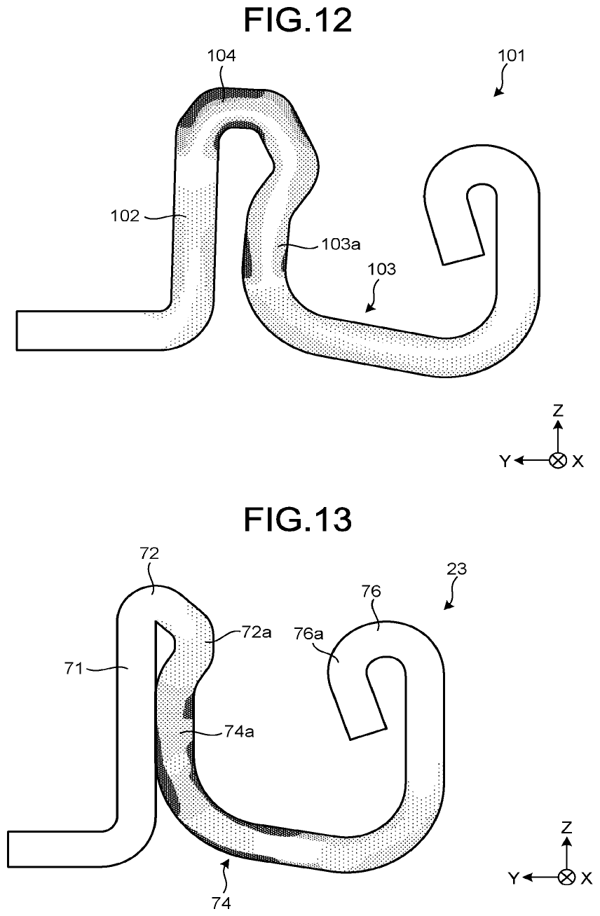

Herein, a comparative example where a configuration of an embodiment as described above is not used will be explained. In a contact 101 of a receptacle connector according to a comparative example, contact between a holding part 102 and a first arm part 103a of a joining part 103 is not caused as illustrated in FIG. 12.

In a case where a plug connector is mated with a receptacle connector in such a comparative example, the first arm part 103a of the joining part 103 is pressed against the holding part 102, so that the contact 101 of the receptacle connector rotates around a folding part 104 as a center thereof and is elastically deformed.

Hence, in the contact 101 of a receptacle connector according to a comparative example, stress concentration may be caused at the folding part 104 so as to degrade the folding part 104 and degrade durability of the contact 101 of the receptacle connector. In FIG. 12, as a stress is increased, a gradation is increased. Additionally, a similar matter is also applied to FIG. 13 as explained below.

On the other hand, in a receptacle connector 20 according to an embodiment, a first arm part 74a of a joining part 74 of a contact 23 contacts a holding part 71 as illustrated in FIG. 11, so that the holding part 71 functions as a stopper for the first arm part 74a. Hence, as illustrated in FIG. 13, it is possible to prevent or reduce generation of stress concentration on a folding part 72, so that it is possible to improve durability of a contact 23 of the receptacle connector 20.

Furthermore, the holding part 71 contacts and holds a first wall part 51a of a housing 21 as illustrated in FIG. 11. Hence, even in a case where a plug connector 10 is mated with the receptacle connector 20, it is possible to prevent or reduce generating of stress concentration on the holding part 71, in particular, a lower end of the holding part 71 and improve durability of a contact 23 of the receptacle connector 20.

Furthermore, contact between the holding part 71 and the first arm part 74a of the joining part 74 is caused, so that it is possible to decrease a length of a contact 23 in forward and backward directions (positive and negative directions of a Y-axis), so that it is possible to downsize the receptacle connector 20.

Furthermore, the joining part 74 is formed into a U-shape. Thereby, it is possible to insert the joining part 74 into a contact 13 of the plug connector 10 so as to interpose the contact 13 between the joining part 74 and each site that is linked thereto. Hence, it is possible to ensure electrical connection between a contact 13 of the plug connector 10 and a contact 23 of the receptacle connector 20.

Furthermore, a contact part 76 is formed into an inverted U-shape and is folded relative to a third arm part 74c of the joining part 74 so as to be joined to a tip of the joining part 74, specifically, an upper end of the third arm part 74c.

Thereby, in a case where the plug connector 10 is mated with the receptacle connector 20, it is possible to elastically deform the third arm part 74c of the joining part 74 and readily execute mating of the plug connector 10 and the receptacle connector 20. For example, it is possible to elastically deform the third arm part 74c by a force that is less than that in a case where the contact part 76 is formed into an elongate shape on the third arm part 74c, so that it is possible to readily execute mating of the plug connector 10 and the receptacle connector 20.

Furthermore, in a case where the plug connector 10 is mated with the receptacle connector 20, it is possible to insert a contact 13 of the plug connector 10 between the first arm part 74a and the third arm part 74c of the joining part 74 by using the contact part 76 as an insertion guide.

Furthermore, for a contact 23 of the receptacle connector 20, a proximal end contact part 72a that protrudes toward the contact part 76 is formed on a part of the folding part 72. The proximal end contact part 72a, together with a distal end contact part 76a that is formed on a part of the contact part 76, contacts a contact 13 of the plug connector 10.

Thereby, it is possible for the receptacle connector 20 to cause contact between a contact 13 of the plug connector 10 and a contact 23 of the receptacle connector 20 by the proximal end contact part 72a and the distal end contact part 76a. Hence, it is possible to ensure electrical connection between a contact 23 of the receptacle connector 20 and a contact 13 of the plug connector 10.

In a case where the plug connector 10 is mated with the receptacle connector 20, the joining part 74 of the receptacle connector 20 is pressed against a contact 13 of the plug connector 10 so as to be elastically deformed. In the joining part 74, a second arm part 74b (a part of the joining part 74) is elastically deformed toward a downward direction (a negative direction of a Z-axis) relative to the first arm part 74a that is held by the holding part 71 and the third arm part 74c (a part of the joining part 74) is deformed toward a central wall part 52.

Specifically, in a case where the plug connector 10 is mated with the receptacle connector 20, the second arm part 74b is elastically deformed from a state where it is separated from a wiring substrate 3, and contacts the wiring substrate 3 so as to be held by the wiring substrate 3 as illustrated in FIG. 11. Furthermore, the third arm part 74c is elastically deformed from a state where it is separated from the central wall part 52, and contacts the central wall part 52 so as to be held by the central wall part 52 as illustrated in FIG. 11. Additionally, the holding part 71 is held by the first wall part 51a on a side wall part 51 of the housing 21.

That is, in a case where the plug connector 10 is mated with the receptacle connector 20, a contact 23 of the receptacle connector 20 is held by the housing 21 and the wiring substrate 3. Hence, it is possible for a contact 23 of the receptacle connector 20 to prevent or reduce unwanted deformation that is associated with insertion of the plug connector 10, by the housing 21 and the wiring substrate 3. Therefore, it is possible to ensure electrical connection between a contact 23 of the receptacle connector 20 and a contact 13 of the plug connector 10.

Additionally, a configuration may be provided in such a manner that, in a case where the plug connector 10 is mated with the receptacle connector 20, the second arm part 74b does not contact the wiring substrate 3 and the third arm part 74c contacts the central wall part 52. Furthermore, a configuration may be provided in such a manner that, in a case where the plug connector 10 is mated with the receptacle connector 20, the second arm part 74b contacts the wiring substrate 3 and the third arm part 74c does not contact the central wall part 52.

Furthermore, for a contact 13 of the plug connector 10, a recess part 40d is formed on a first arm part 40a. Then, in a state where the plug connector 10 is mated with the receptacle connector 20, the proximal end contact part 72a of the joining part 74 of the receptacle connector 20 engages with the recess part 40d.

Thereby, it is possible to hold electrical connection between a contact 23 of the receptacle connector 20 and a contact 13 of the plug connector 10 and prevent or reduce removing the plug connector 10 from the receptacle connector 20.

Furthermore, for the receptacle connector 20, a gap G that is capable of viewing a tip of a terminal part 70 of a contact 23 is formed between the first wall part 51a of the housing 21 and a first side wall part 61 of a shell member 22.

Thereby, it is possible to view a jointing state of the terminal part 70 of a contact 23 and the wiring substrate 3.

5. Another/Other Configuration(s) of Connector

A contact 23 of a receptacle connector 20 according to a variation may be configured in such a manner that a proximal end contact part 72a is not provided thereon. That is, a contact 23 of the receptacle connector 20 may join another end part of a folding part 72 where the proximal end contact part 72a is not formed and an upper end of a first arm part 74a of a joining part 74.

Furthermore, a contact 13 of a plug connector 10 according to a variation may form a recess part on a second arm part 40b. Specifically, a contact 13 of the plug connector 10 according to a variation may form a recess part on the second arm part 40b so as to engage with a distal end contact part 76a that is formed on a contact 23 of a receptacle connector 20.

Thereby, it is possible to hold electrical connection between a contact 23 of a receptacle connector 20 and a contact 13 of a plug connector 10 and prevent or reduce readily removing the plug connector 10 from the receptacle connector 20.

Furthermore, a connector 1 according to a variation may be a connector where a plug connector 10 that is attached to a cable is mated with a receptacle connector 20. In such a case, although contacts 23 are arranged in two columns in forward and backward directions (positive and negative directions of a Y-axis) in the present embodiment, one column thereof may be provided.

According to an aspect of an embodiment, it is possible to provide an electrical connector and an electrical connector device that are capable of improving durability thereof.

It is possible for a person(s) skilled in the art to readily derive an additional effect(s) and/or variation(s). Hence, a broader aspect(s) of the present invention is/are not limited to a specific detail(s) and a representative embodiment(s) as illustrated and described above. Therefore, various modifications are possible without departing from the spirit or scope of a general inventive concept that is defined by the appended claim(s) and an equivalent(s) thereof.

What is claimed is:

1. An electrical connector, comprising:
a housing; and
a contact that is attached to the housing and is connected to a wiring substrate, wherein
the contact includes:
a connection part that is connected to the wiring substrate;
a holding part that is joined to the connection part and extends in a direction away from the wiring substrate;
a joining part that is joined to the holding part through a folding part, extends in a direction closer to the wiring substrate, extends so as to be provided along a principal surface of the wiring substrate, and further extends in a direction away from the wiring substrate; and
a contact part that is joined to the joining part and contacts a counterpart contact of a counterpart connector, and
the joining part contacts the holding part.

2. The electrical connector according to claim 1, wherein
the holding part contacts a side wall part of the housing and is held by the side wall part.

3. The electrical connector according to claim 1, wherein
the contact part is folded into an inverted U-shape and is joined to a tip of the joining part.

4. The electrical connector according to claim 1, further comprising
a proximal end contact part that protrudes toward the contact part, on a part of the folding part, wherein
the proximal end contact part, together with the contact part, contacts a counterpart contact of the counterpart connector.

5. The electrical connector according to claim 1, wherein
the housing includes a central wall part that faces a part of the joining part, and
a part of the joining part is elastically deformed from a state where it is separated from the central wall part, to contact the central wall part, in a case where the counterpart connector is mated therewith.

6. The electrical connector according to claim 5, wherein
a part of the joining part is elastically deformed from a state where it is separated from the wiring substrate, to contact the wiring substrate, in a case where the counterpart connector is mated therewith.

7. The electrical connector according to claim 1, further comprising
a shell that is provided on an outer periphery of the housing, wherein
a gap that is capable of viewing a tip of the connection part is formed between the housing and the shell.

8. An electrical connector device, comprising:
the electrical connector according to claim 1; and
the counterpart connector, wherein
a recess part that engages with the contact part is formed on the counterpart contact.
